(19) United States
(12) Patent Application Publication
(10) Pub. No.: US 2004/0140291 A1
(43) Pub. Date: Jul. 22, 2004

(54) Copper etch

(76) Inventors: Eric D. Swanson, Aloha, OR (US); Cliff Bugge, Portland, OR (US)

Correspondence Address: Leo J. Peters, LSI LOGIC CORPORATION, M/S D-106, 1551 McCarthy Boulevard, Milpitas, CA, 95035, US

(21) Appl. No.: 10/348,057

(22) Filed: Jan. 20, 2003

(51) Int. Cl. B44C 1/22

(52) U.S. Cl. 216/105

(57) ABSTRACT

A method of deprocessing damascene type integrated circuits which include copper (Cu) and tantalum nitride (TaN) layers is provided. An etch is used which includes an acetic salt in a solution with an hydroxide. The acetic salt etches the copper layer.

### FIELD OF THE INVENTION

The present invention relates to copper etches. More specifically, the present invention relates to a wet etch for deprocessing integrated circuits which include copper layers.

### BACKGROUND OF THE INVENTION

Integrated circuits (ICs) have found widespread use in electronic equipment in many different fields. There has been an ongoing trend to miniaturize the components on integrated circuits in which the components and their interconnects are closely spaced to provide extremely high density. This has followed a historical trend known as “Moore's Law.”

Traditionally, integrated circuits have been largely planar devices in which the components are laid out across the substrate. In order to increase component density, more than one number of layer of metal interconnects are used on the semiconductor substrate. One limitation on the speed of the integrated circuit is the electrical resistance and capacitance due to the interconnects which extend between the components on the IC. These connections have typically been made with aluminum. However, newer techniques use copper which offers a low resistance material. The copper is used with a low-k dielectric material which reduces problems associated with capacitance between the interconnects. One technique used to provide high density copper based interconnects is a fabrication process called “dual damascene.” In a integrated circuit formed using a damascene process, copper vias or trenches extend through one or more low-k dielectric layers and connect to an underlying copper layer.

When semiconductor devices fail, it is desirable from an engineering, development and manufacturing standpoint to understand the point of failure such that the problem which caused the failure can be identified and eliminated. One technique to identify failures is known as “deprocessing” in which the various layers of the semiconductor integrated circuit are removed, one or more layer at a time, such that the device can be inspected in detail. Techniques are available for deprocessing tradition semiconductor integrated circuits. For example, etchants can be used which selectively remove the desired layers. However, such deprocessing of semiconductor integrated circuits which include copper layers, such as those processed using damascene techniques, have been problematic. It has been difficult to etch a copper layer without etching other layers of the integrated circuit. Typically copper etches may etch dielectric layers or other layers. Standard etching techniques tend to damage the surrounding dielectric material. Further, typical wet copper etchants also typically remove other layers such as SiO₂ layers and TaN layers. Additionally, plasma based etch chemistry does not readily form volatile materials and is therefore ineffective in etching the copper.

### SUMMARY OF THE INVENTION

A method of etching copper and a copper etch are provided. An acetic salt is formed in a solution by reacting in acid with a hydroxide or other base. The acetic salt is applied to a copper layer, to etch the copper layer. Sufficient acid is supplied to the solution to substantially completely consume the hydroxide or other base.

### BRIEF DESCRIPTION OF THE DRAWINGS

FIG. 1 is a cross-sectional view of a portion of an integrated circuit having a copper layer.

FIG. 2 is a cross-sectional view similar to FIG. 1 in which the copper layer has been removed.

### DETAILED DESCRIPTION OF THE PREFERRED EMBODIMENTS

The present invention is directed to a technique for processing integrated circuits which include a copper layer. One such integrated circuit is fabricated using damascene (including dual demascene) structures. During fabrication of the structures, two general techniques are used. One is known as the “trench first” approach and another is known as the “via-first” approach. In either case, a trench or via in a low-k dielectric layer is formed and filled with a copper layer.

In general, the techniques used to fabricate dual damascene structures do not use steps which require a copper etch to form a structure. This is because copper does not form a volatile byproduct and is therefore difficult to etch. Instead, after vias and trenches are formed and filled with copper. The copper is polished to achieve the desired interconnect structure.

When such a damascene structure fails, it is often desirable to “deprocess” the structure, layer by layer, such that the source of the failure can be specifically identified. However, with the use of copper and low-k dielectric materials in integrated circuit designs, standard deprocessing techniques are not adequate to provide such a layer by layer deprocessing of the circuitry. Typically, copper etches also tend to etch other layers of the structure making layer by layer deprocessing difficult.

The present invention provides a technique to remove single and dual damascene copper metallization layers, one level at a time. Standard planar polishing (known as “p-lapping”) is inadequate for this task due to the difference in removal rates of the copper and surrounding dielectric materials. Further, this is aggravated by the variation in the pattern density. On the other hand, typical wet chemical etch solution used to remove copper also tend to remove surrounding layers of silicon dioxide (SiO₂) and titanium nitride (TaN). Thus, such etchants do not allow the controlled removal of an individual metal copper layer. Further, plasma based etch chemistries do not form volatile materials and are thus also ineffective.

In a specific example, the present invention provides a wet chemical etch that utilizes the relatively stable and unstable oxidative states of TaN and Cu. In a specific example, is of the following form:

CH₃COOH+KOH+H₂O₂

### Example 1

With a concentration ratio of 10:2.1:10, respectively.

In one specific example, the etchant is applied to the surface of the semiconductor at a temperature of about 50° C. The etchant attacks elemental Cu very aggressively, with a high level of selectivity to the surrounding low-k dielectric material and SiC. Further, this action is highly selective relative to TaN which is used as a seed layer in some processes. Thus, the etch will stop at the TaN seed layer. At lower temperatures, such as at room temperature, the etching is much slower and can be used effectively as a delineation etch for use in, for example, cross-sectional scanning electron microscope (SEM) sample preparation.

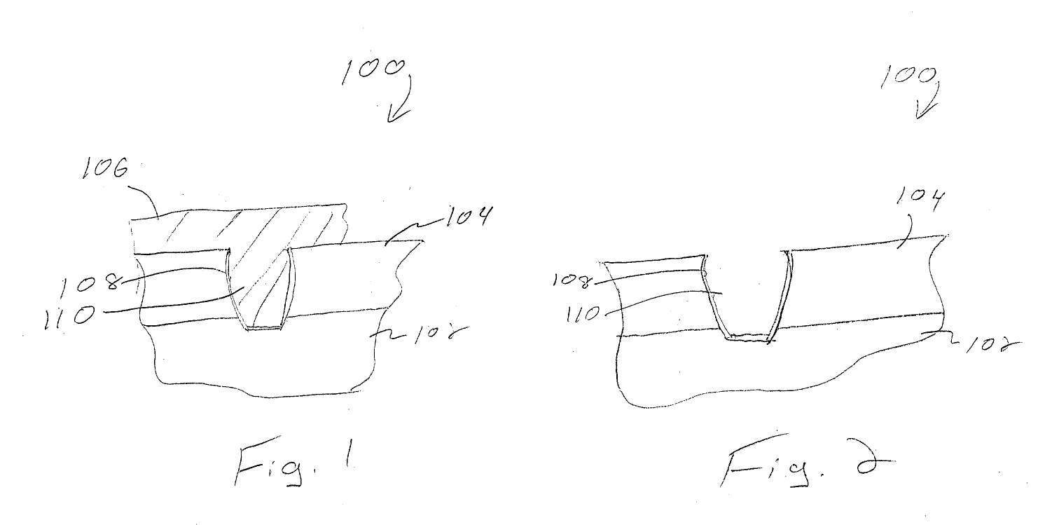

FIG. 1 is a cross-sectional view of a portion of an integrated circuit 100 and illustrates a dual damascene structure. An underlying copper layer 102 supports a low-k dielectric layer 104. An overlying copper layer 106 extends through a trench or a via 110 and contacts copper layer 102. The copper layer 106 is deposited upon a TaN seed layer 108.

In order to deprocess integrated circuit 100, a wet chemical etch is applied to the integrated circuit 100 in accordance with the present invention as set forth in Example 1. With a temperature at about 50° C., after about 90 seconds the copper layer 106 is removed to leave the structure as illustrated in FIG. 2. FIG. 2 is a cross-sectional view of integrated circuit 100 of FIG. 1 in which the copper layer 106 has been removed.

In a more general aspect, the present invention provides a method of deprocessing a damascene type integrated circuit by forming an acetic salt in a solution by reacting the acid with hydroxide or other base. The acetic salt is applied to the integrated circuit to etch a copper layer without significantly etching other layers such as a titanium nitride (TaN) layer which is used as a seed layer. During the etching, in one aspect the method includes maintaining sufficient acidity of the solution by supplying a sufficient quantity of acid to the solution to substantially completely consume the hydroxide.

The etch of the present invention is configured to take advantage of the fact that the acetic salt readily forms compositions with transition metal. Both copper and tantalum are transition metals. However, in some semiconductor configurations the copper exists as elemental copper while the tantalum exists as tantalum nitride (TaN). The Cu—Cu bond is relatively weak and has a relatively low energy level. In contrast, the TaN bond is a very strong and stable covalent bond. The etch of the present invention exploits this difference in bonding and energies such that the copper is attacked without damage to the tantalum nitride.

In the example set forth in Example 1, the etch is formed in a 45% aqueous solution of potassium hydroxide (KOH) in which acetic acid (COOH₃) is added until a mixture of pH of 5 is obtained. As the potassium hydroxide is an etchant of silicon and metals, an acetic pH should be maintained to ensure that all of the KOH is consumed in the formation of potassium acetate (COOH₃COOK), an acetic salt. Although, a pH 5 is described, other pH levels can be used. Preferably, the solution is acetic to ensure that the KOH is substantially completely consumed by the acid.

This solution etches copper relatively slowly at room temperature. However, at higher temperatures, such as 50° C., the etch rapidly consumes elemental copper while not substantially affecting the TaN seed layer or other layers in the semiconductor structure. Thus, this etchant is well suited to remove a Cu metallization layer, one single layer at a time, from damascene semiconductor structures.

In another example, the etchant can be used at a lower temperature, such as room temperature in conjunction with a fluorine containing solution. Such a solution can be used to provide a delineating treatment for use with SEM cross-sectional sample preparation. The etchant can also be used to etch Tungsten when hydrogen peroxide is added to the mixture.

The steps etching copper in accordance with the invention are as follows:

CH₃COOH+KOH=>CH₃COOK+H₂O EQ. 1

CH₃COOK+Cu=>Cu(O₂CCH₃)2+H₂O EQ. 2

With the present invention, a single layer of copper metallization can be removed and the underlying structure examined. Next, a seed layer or other layer can be removed using other known etching techniques. The semiconductor can again be inspected for defects. When another copper layer is reached, the etchant of the present invention can be used again to remove that single layer of copper. Thus, a deprocessing technique is provided in which each layer of semiconductor structure can be removed, a single layer at a time and the semiconductor inspected for defects.

In the solution, CH₃COOH:KOH can range between about 10:0.1 and about 10:6.0, and other components such as H₂O₂ can range between about 0% and about 50%. For complete etching of copper layers, temperatures higher than room temperature are typically used although not required. For example, a temperature range of between about 20° C. and about 80° C. Typical durations for complete etching of a copper layer are between about 10 sec and about 30 min. For delineating, temperatures typically range between about 20° C. and about 40° C. and durations range between about 5 sec and about 20 sec. As mentioned above, to ensure that the KOH is completely consumed, it is preferable that the solution be maintained acetic. For example, the pH of the solution should be about pH 3.0 and about pH 7.0. The acetic acid will selectively etch the Cu, but extremely slowly. The amount of KOH added to the solution (and the formation of the acetate salts) accelerates the etch and widens the selectivity. The ratios indicated reflect very small amounts of KOH to approximate what would be added to bring the solution to a neutral pH.

Although the present invention has been described with reference to preferred embodiments, workers skilled in the art will recognize that changes may be made in form and detail without departing from the spirit and scope of the invention.

Although the specific example set forth in Example 1 shows CH₃COOH reacting with KOH, in other more general aspects the invention includes etching a copper layer with an acetic salt. The acetic salt can be formed by reacting acetic acid with a base. One specific type of base is a hydroxide.

What is claimed is:

1. A method of deprocessing treating damascene type integrated circuit which includes a copper (Cu) layer and tantalum nitride (TaN) layer, comprising:
forming an acetic salt in a solution by reacting in acid with a hydroxide;
applying the acetic salt to the integrated circuit to etch the copper layer;
supplying sufficient acid to the solution to substantially completely consume the hydroxide; and
etching the copper layer with the acetic salt.

2. The method of claim 1 in which the acetic salt comprises CH₃COOK.

3. The method of claim 1 in which the acid comprises CH₃COOH.

4. The method of claim 1 in which the hydroxide includes an alkali.

5. The method of claim 1 wherein the hydroxide comprises KOH.

6. The method of claim 1 in which a pH of at least 5 is maintained in the solution.

7. The method of claim 1 in which a pH of between 3 and 7 is maintained.

8. The method of claim 1 in which the temperature of the solution is in a range of between about 20° C. and about 80° C.

9. The method of claim 1 wherein the copper layer is substantially completely removed by reaction with the acetic salt.

10. The method of claim 1 wherein the copper layer is partially removed by reaction with the acetic salt to delineate the copper layer.

11. The method of claim 1 wherein the acetic salt applied to the integrated circuit for more than about 10 seconds.

12. The method of claim 1 wherein forming an acetic salt comprises combining CH₃COOH and KOH in an aqueous solution.

13. The method of claim 12 wherein the ratio of CH₃COOH and KOH is in a range of between about 10:0.1 and about 10:0.6.

14. The method of claim 12 wherein the ratio of CH₃COOH and KOH is about 10:2.1.

15. The method of claim 1 wherein the etching of the copper layer is performed at a sufficiently low temperature to partially etch the copper layer thereby delineating the copper layer.

16. The method of claim 15 wherein the temperature is room temperature.

17. The method of claim 10 wherein the temperature of the solution is between about 20° C. and about 40° C.

18. The method of claim 10 wherein the acetic salt is applied to the integrated circuit for between about 5 seconds and about 20 seconds.
